(19) United States
(12) Patent Application Publication
(10) Pub. No.: US 2012/0056137 A1
(43) Pub. Date: Mar. 8, 2012

(54) Apparatus for and Method of Preparing Titanium Dioxide Sol and Paste Composition Using the Same

(75) Inventors: Woo Sug Yoon, Gyeonggi-do (KR); Ho Seok Lee, Gyeonggi-do (KR); Dong Hyun Kim, Gyeonggi-do (KR); Tai Kyu Lee, Gyeonggi-do (KR)

(73) Assignee: NANOPAC LTD., Suwon-si, Gyeonggi-do (KR)

(21) Appl. No.: 13/120,915

(22) PCT Filed: Sep. 7, 2009
(86) PCT No.: PCT/KR2009/005044

§ 371 Date: Nov. 21, 2011

(30) Foreign Application Priority Data
Sep. 26, 2008 (KR) 10-2008-0094696

(51) Int. Cl. H01B 1/12; B01J 19/00

(52) U.S. Cl. 252/519.3; 422/255

(57) ABSTRACT

An apparatus for preparing a titanium dioxide (TiO₂) sol is provided. The apparatus includes a storage unit configured to store an organic solvent mixture containing an aqueous titanium dioxide sol and a dispersing stabilizer, a separation unit connected to and installed at the storage unit and configured to separate the organic solvent mixture into titanium dioxide particles and an organic solvent mixture containing water and the dispersing stabilizer, a circulating solution transfer path connected and installed between the separation unit and storage unit and configured to transfer the titanium dioxide particles separated by the separation unit to the storage unit, and a discharge unit connected to and installed at one side of the separation unit and configured to discharge an organic solvent mixture containing the water and dispersing stabilizer separated by the separation unit.

### TECHNICAL FIELD

The present invention relates to an apparatus for and a method of preparing a titanium dioxide sol, and more particularly, an apparatus for and a method of preparing a titanium dioxide (TiO₂) sol used for titanium dioxide paste for a screen printing process from an aqueous titanium dioxide sol using a solvent replacement process.

### BACKGROUND ART

Paste for a screen printing process, preferably, titanium dioxide (TiO₂) paste for a screen printing process, is coated on conductive glass, a conductive film, or a conductive polymer and used as a metal oxide electrode of a dye-sensitized solar cell.

In particular, manufacturing of a dye-sensitized solar cell involves injecting an iodic oxidation/reduction electrolyte between an electrode coated with a porous nano-oxide particle thin film adsorbed with ruthenium (Ru)-based dye and a counter electrode coated with a platinum (Pt) or carbon (C) catalyst and sealing the resultant structure.

Since optical conversion efficiency of the dye-sensitized solar cell depends on the product of the current density, voltage, and fill factor of a solar cell, the current density, the voltage, and the fill factor should be improved to increase energy conversion efficiency. Among these, methods for boosting the voltage of the solar cell can include a method of increasing the current density by minimizing the recombination reaction by reforming a surface state, a method of negatively increasing conduction band energy of a nanoparticle oxide with respect to a standard hydrogen electrode potential, and a method of positively increasing the oxidation-reduction potential of an iodic electrolyte with respect to a standard hydrogen electrode potential.

Here, the manufacturing of the dye-sensitized solar cell requires preparing a titanium dioxide nanoparticle thin film as the conductive material with a large specific surface area. Thus, the screen printing process is appropriate to coat the conductive material with a metal oxide electrode. The screen printing process may be performed using titanium dioxide paste for a screen printing process containing a highly viscous organic solvent, such as terpineol.

To prepare the titanium dioxide paste for the screen printing process, commercialized nanoscale titanium dioxide powder is used or titanium dioxide is synthesized by performing a sol-gel process or hydrothermal process on a titanium dioxide precursor, such as alkoxide or titanium tetrachloride (TiCl₄) and powdered. To promote mixture of the titanium dioxide powder with a highly viscous organic solvent, such as terpineol, the titanium dioxide powder is ground and dispersed in an organic solvent, such as ethyl alcohol, using an attrition milling apparatus.

Here, since the above-described conventional method of preparing titanium dioxide paste for a screen printing process employs the attrition milling apparatus, the method consists of complicated processes and is inappropriate for mass production, thus reducing mass productivity and economical efficiency.

### DISCLOSURE

### Technical Problem

The present invention is directed to preparation of a titanium dioxide (TiO₂) sol dispersed in an organic solvent in large quantities by replacing the titanium dioxide sol dispersed in water with an organic solvent using a separation unit before powdering titanium dioxide during preparation of a commercialized aqueous titanium dioxide sol or titanium dioxide sol.

Also, the present invention is directed to a method of preparing titanium dioxide paste for a screen printing process, which may be applied to a screen printing method appropriate for mass production, by replacing a titanium dioxide sol dispersed in water with an organic solvent using a separation unit before powdering titanium dioxide during preparation of a commercialized aqueous titanium dioxide sol or titanium dioxide sol.

### Technical Solution

One aspect of the present invention provides an apparatus for preparing a titanium dioxide sol, including: a storage unit configured to store an organic solvent mixture containing an aqueous titanium dioxide sol and a dispersing stabilizer; a separation unit connected to and installed at the storage unit and configured to separate the organic solvent mixture into titanium dioxide particles and the organic solvent mixture containing water and the dispersing stabilizer; a circulating solution transfer path connected and installed between the separation unit and storage unit and configured to transfer the titanium dioxide particles separated by the separation unit to the storage unit; and a discharge unit connected to and installed at one side of the separation unit and configured to discharge the organic solvent mixture containing the water and the dispersing stabilizer separated by the separation unit.

Another aspect of the present invention provides a method of preparing a titanium dioxide sol, including: (a) preparing an organic solvent mixture containing a dispersing stabilizer by mixing 1 to 30 parts by weight dispersing stabilizer and 70 to 99 parts by weight organic solvent; (b) preparing an organic solvent mixture containing an aqueous titanium dioxide sol and the dispersing stabilizer by mixing the organic solvent mixture containing the dispersing stabilizer of step (a) with the aqueous titanium dioxide sol in a volume ratio of 1:1 to 1:9; (c) replacing water with an organic solvent by separating the organic solvent mixture containing the aqueous titanium dioxide sol and the dispersing stabilizer of step (b) into titanium dioxide particles and an organic solvent mixture containing water and the dispersing stabilizer using a separation unit; (d) circulating the separated titanium dioxide particles obtained in step (c) and mixing the separated titanium dioxide particles with the mixture of step (b); and (e) repetitively allowing the organic solvent mixture prepared in step (b) to sequentially undergo steps (c) and (d) until the organic solvent has a purity degree of 95% or higher.

Another aspect of the present invention provides a method of preparing a paste composition for a screen printing process, including mixing titanium dioxide sol prepared according to the above method with a dispersant, a binder, a surfactant, or all thereof and homogenizing the resultant mixture.

### Advantageous Effects

A titanium dioxide (TiO₂) sol dispersed in an organic solvent according to the present invention may have good long-term storage capability and be in a nanoscale colloidal state without undergoing a conventional attrition milling process to enable manufacture of a transparent paste electrode.

In addition, the present invention provides a titanium dioxide paste composition for a screen printing process, which may be applied to a screen printing method appropriate for mass production.

### DESCRIPTION OF DRAWINGS

FIG. 1 is a construction diagram of an apparatus for preparing a titanium dioxide (TiO₂) sol, according to the present invention;

FIG. 2 is graphs showing a comparison in particle size distribution according to exemplary embodiments of the present invention;

FIG. 3 is transmission electron microscope (TEM) images according to an exemplary embodiments of the present invention;

FIG. 4 is a graph showing a viscosity variation according to an exemplary embodiment of the present invention;

FIG. 5 is an image of a solvent-replaced titanium dioxide sol according to an exemplary embodiment of the present invention and a comparative example; and

FIG. 6 is a graph showing a photocurrent density relative to an optical voltage of a dye-sensitized solar cell according to an exemplary embodiment of the present invention.

** Brief Description of Major Parts in the Drawings**

| | | | |
|---|---|---|---|
| 2: | Storage unit | 4: | Separation unit |
| 6: | Heat exchange unit | 8: | Wash tank |
| 10: | Organic solvent injector | 12: | Discharge unit |
| 14: | Circulating solution transfer path | | |
| 16: | Cleaning solution transfer path | | |
| 18: | pH measurer | | |

### MODE FOR INVENTION

Hereinafter, exemplary embodiments of the present invention will be described in detail. However, the present invention is not limited to the exemplary embodiments disclosed below, but can be implemented in various types. Therefore, the present exemplary embodiments are provided for complete disclosure of the present invention and to fully inform the scope of the present invention to those ordinarily skilled in the art.

According to one exemplary embodiment, the present invention provides an apparatus for preparing a titanium dioxide (TiO₂) sol, including: a storage unit configured to store an organic solvent mixture containing an aqueous titanium dioxide sol and a dispersing stabilizer; a separation unit connected to and installed at the storage unit and configured to separate titanium dioxide particles from an organic solvent mixture containing water and a dispersing stabilizer; a circulating solution transfer path connected and installed between the separation unit and storage unit and configured to transfer the titanium dioxide particles separated by the separation unit to the storage unit; and a discharge unit connected to and installed at one side of the separation unit and configured to discharge an organic solvent mixture containing the water and dispersing stabilizer separated by the separation unit.

According to another exemplary embodiment, the present invention provides a method of preparing a titanium dioxide sol, including: (a) preparing an organic solvent mixture containing a dispersing stabilizer by mixing 1 to 30 parts by weight dispersing stabilizer and 70 to 99 parts by weight organic solvent; (b) preparing an organic solvent mixture containing an aqueous titanium dioxide sol and the dispersing stabilizer by mixing the organic solvent mixture containing the dispersing stabilizer of step (a) with the aqueous titanium dioxide sol in a volume ratio of 1:1 to 1:9; (c) replacing water with an organic solvent by separating the organic solvent mixture containing the aqueous titanium dioxide sol and the dispersing stabilizer of step (b) into titanium dioxide particles and an organic solvent mixture containing water and the dispersing stabilizer using a separation unit; (d) circulating the separated titanium dioxide particles obtained in step (c) and mixing the separated titanium dioxide particles with the mixture of step (b); and (e) repetitively allowing the organic solvent mixture prepared in step (b) to sequentially undergo steps (c) and (d) until the organic solvent has a purity degree of 95% or higher.

According to another exemplary embodiment, the present invention provides a method of preparing a paste composition for a screen printing process, including mixing a titanium dioxide sol prepared according to the above method with a dispersant, a binder, a surfactant, or all thereof and homogenizing the resultant mixture.

The apparatus for preparing a titanium dioxide sol according to the present invention may be used to prepare a titanium dioxide sol dispersed in an organic solvent by replacing a titanium dioxide sol dispersed in water with an organic solvent using a separation unit before powdering titanium dioxide during preparation of a commercialized aqueous titanium dioxide sol or titanium dioxide sol. The apparatus for preparing the titanium dioxide sol according to the present invention may be any one of typically known titanium dioxide sol preparation apparatuses used in the art for the above-described purposes.

Here, the separation unit may be configured to separate the titanium dioxide particles from the organic solvent containing water and the dispersing stabilizer to replace water contained in the aqueous titanium dioxide sol with the organic solvent. The separation unit may be any one of typically known separation units used in the art for the above-described purposes. However, the separation unit may preferably be a separation unit containing a separation membrane or filtration membrane, more preferably, an ultrafiltration membrane. In this case, the organic solvent containing the water and the dispersing stabilizer separated by the separation unit may be inclusively referred to as a filtration solution.

In addition, the aqueous titanium dioxide sol, which is a target material to be replaced with a solvent using the apparatus for preparing the titanium dioxide sol according to the present invention, may be, but is not specifically limited to, water in which titanium dioxide particles are dispersed. Preferably, the aqueous titanium dioxide sol may contain titanium dioxide at a content of 20 to 30 parts by weight, based on 100 parts by weight titanium dioxide sol, and the titanium dioxide particles may have a size of 10 to 100 nm and a specific surface area of 40 to 350 m²/g.

Hereinafter, the present invention will be described in detail with reference to the appended drawings. However, it should be understood that the description proposed herein is just a preferable example for the purpose of illustrations only, not intended to limit the scope of the invention.

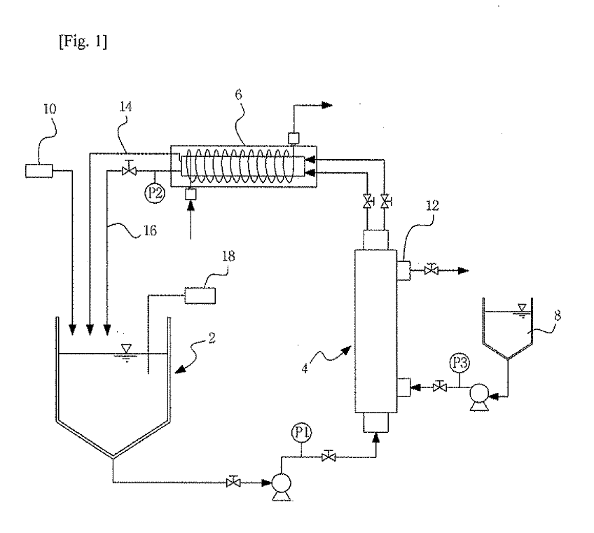

FIG. 1 is a construction diagram of an apparatus for preparing a titanium dioxide sol according to an exemplary embodiment of the present invention.

Referring to FIG. 1, the apparatus for preparing the titanium dioxide sol according to the present invention may include a storage unit 2 configured to store an organic solvent mixture containing an aqueous titanium dioxide sol and a dispersing stabilizer, a separation unit 4 connected to and installed at the storage unit 2 and configured to separate the organic solvent mixture into titanium dioxide particles and an organic solvent mixture containing water and the dispersing stabilizer, a circulating solution transfer path 14 connected and installed between the separation unit 4 and the storage unit 2 and configured to transfer the titanium dioxide particles separated by the separation unit 4 to the storage unit 2, and a discharge unit 12 connected to and installed at one side of the separation unit 4 and configured to discharge the organic solvent mixture containing the water and the dispersing stabilizer separated by the separation unit 4.

According to one exemplary embodiment, the apparatus for preparing the titanium dioxide sol according to the present invention may further include a wash tank 8 connected to and installed at one side of the separation unit 4 and filled with a cleaning solution required to wash the separation unit 4 and a cleaning solution transfer path 16 connected and installed between the separation unit 4 and the storage unit 2 and configured to transfer the cleaning solution used in the separation unit 4 to the storage unit 2.

According to another exemplary embodiment, the apparatus for preparing the titanium dioxide sol according to the present invention may further include a heat exchange unit 6 included in the circulating solution transfer path 14 and configured to control the temperature of the titanium dioxide particles separated by the separation unit 4 or a heat exchange unit 6 included in the cleaning solution transfer path 16 and configured to control the temperature of the cleaning solution used to wash the separation unit 4.

According to another exemplary embodiment, the apparatus for preparing the titanium dioxide sol according to the present invention may further include an organic solvent injector 10 installed at one side of the storage unit 2. Here, an organic solvent containing the dispersing stabilizer is injected into the organic solvent injector 10.

According to another exemplary embodiment, the apparatus for preparing the titanium dioxide sol according to the present invention may further include a pH measurer 18 connected to and installed at one side of the storage unit 2 and configured to control the pH value of the organic solvent mixture containing the aqueous titanium dioxide sol and the dispersing stabilizer stored in the storage unit 2.

The aqueous titanium dioxide sol according to the present invention may be, but is not specifically limited to, water in which titanium dioxide particles are dispersed. Preferably, the aqueous titanium dioxide sol may contain titanium dioxide at a content of 20 to 30 parts by weight, based on 100 parts by weight titanium dioxide sol, and the titanium dioxide particles may have a size of 10 to 100 nm and a specific surface area of 40 to 350 m²/g.

The storage unit 2 according to the present invention may provide a place where the organic solvent mixture containing an aqueous titanium dioxide sol, which is a target material, used to replace water with an organic solvent, and the dispersing stabilizer is stored. The storage unit 2 may be any storage unit used for the above-described purpose.

In this case, the apparatus may further include an organic solvent injector 10 installed at one side of the storage unit 2 and configured to provide the organic solvent containing the dispersing stabilizer to the storage unit 2 and/or a pH measurer 18 configured to measure a pH value of the organic solvent mixture containing the aqueous titanium dioxide sol and the dispersing stabilizer stored in the storage unit 2 to control the pH value of the organic solvent mixture. Here, a meter may be used as the pH measurer 18.

Meanwhile, the organic solvent containing the dispersing stabilizer mixed with the aqueous titanium dioxide sol and stored in the storage unit 2 according to the present invention is used to replace a titanium dioxide sol dispersed in water with a solvent. The organic solvent may be, but is not specifically limited to, any one of typically known organic solvents used in the art for the above-described purposes. Preferably, the organic solvent may be a mixture of 1 to 30 parts by weight dispersing stabilizer and 70 to 99 parts by weight organic solvent, based on 100 parts by weight thereof. In this case, although the content of the dispersing stabilizer is not specifically limited, it is recommended that the dispersing stabilizer be added at a content of 1 to 15 parts by weight because the purity of the solvent may be reduced due to an additive when a titanium dioxide paste composition for a screen printing process is prepared using a titanium dioxide sol replaced with an organic solvent.

Here, the dispersing stabilizer may be used with no particular limitation when the dispersing stabilizer is any material capable of providing dispersing stability to a titanium dioxide sol, but a β-diketone may be typically used as the dispersing stabilizer. In this case, the β-diketone forms chelates with surfaces of particles to reduce surface tension between the particles and the solvent so that separation of the particles from the solvent can be prevented to inhibit cohesion of the particles. Also, when applied during the coating process, the β-diketone facilitates cohesion between particles. The β-diketone is typically present as an equilibrium mixture between a keto form and an enol form and has a different equilibrium position according to the properties of the solvent.

Furthermore, the β-diketone may form chelates with several metals, and the chelates are stable and mostly dissolved in an organic solvent more than in water.

The dispersing stabilizer may be acetylacetone and/or an organic polymer such as polyvinylalcohol (PVA).

In addition, the organic solvent mixed with the dispersing stabilizer may be, but is not limited to, a hydrophilic organic solvent, preferably, an alcohol-based material with a purity degree of 95% or higher, such as ethanol, methanol, ethylene glycol, or 1-propanol, more preferably, ethanol or methanol.

Meanwhile, the organic solvent mixture containing the aqueous titanium dioxide sol and the dispersing stabilizer stored in the storage unit 2, according to the present invention, may be obtained by mixing the aqueous titanium dioxide sol and the dispersing stabilizer in a volume ratio of 1:1 to 1:9, preferably, in a volume ratio of 1:1 to 1:2. The solvent replacement process should be sequentially repeated until the organic solvent has a purity degree of 95% or more. Also, the aqueous titanium dioxide sol and the organic solvent mixture may be mixed nearly in an equivalent ratio to prepare solvent-replaced titanium dioxide sol more effectively.

The separation unit 4 according to the present invention may be configured to separate titanium dioxide particles and the organic solvent mixture containing water and the dispersing stabilizer from each other to replace water contained in an aqueous titanium dioxide sol with an organic solvent. The separation unit 4 may be any one of typically known separation units used in the art for the above-described purposes. Preferably, the separation unit 4 may be a separation unit containing a separation membrane or a filtration membrane, more preferably, an ultrafiltration membrane.

In addition, the organic solvent mixture (or filtrating solution) containing the water and the dispersing stabilizer separated by the separation unit 4 according to the present invention, specifically, the separation unit 4 including an ultrafiltration membrane, is externally discharged through the discharge unit 12 connected to and installed at one side of the separation unit 4, and the remaining titanium dioxide particles (or solid content) may be circulated toward the storage tank 2.

In this case, when the aqueous titanium dioxide sol and the organic solvent mixture containing the dispersing stabilizer stored in the storage tank 2 are reduced to 50% or more of the initial capacity of the storage tank 2, the storage tank 2 is filled with the organic solvent mixture containing the dispersing stabilizer to as much as the reduced amount.

Furthermore, when the separation unit 4 according to the present invention is used to continuously replace an aqueous titanium dioxide sol with a solvent, since a void of the separation unit 4, specifically, a void of an ultrafiltration membrane, may be clogged with titanium dioxide particles contained in the titanium dioxide sol, the separation layer 4 needs to be periodically washed to solve the above problem. Accordingly, a wash tank 8 filled with a cleaning solution required for washing the separation unit 4 may be further connected to and installed at one side of the separation unit 4 according to the present invention.

In this case, the separation unit 4, specifically, the ultrafiltration membrane, is washed with the cleaning solution of the wash tank 8, and titanium dioxide particles removed by washing, using the cleaning solution, may be transferred along with the cleaning solution to the storage unit 2 through a cleaning solution transfer path 16 that provides a path through which the cleaning solution may be transferred to the storage unit 2 between the separation unit 4 and the storage unit 2.

A circulating solution transfer path 14 according to the present invention may provide a path through which the titanium dioxide particles separated by the separation unit 4 are transferred to the storage unit 2 and circulated. The circulating solution transfer path 14 may not be specifically limited but be any one of typically known transfer paths used in the art for the above-described purposes.

Meanwhile, a method of preparing a solvent-replaced titanium dioxide sol using a solvent replacement process according to the present invention may be preferably performed at room temperature or lower, for example, at a low temperature of 4 to 20° C., to prevent gelation of sol during the solvent replacement process. To perform the solvent replacement process at a low temperature, the apparatus may further include the circulating solution transfer path 14 connected and installed between the separation unit 4 and the storage unit 2 and a heat exchange unit 6 (e.g., heat exchanger) configured to control temperatures of titanium dioxide particles and a liquid containing the same transferred to the cleaning solution transfer path 16.

In addition, a titanium dioxide sol obtained by replacing water with an organic solvent through a solvent replacement process using the separation unit 4 according to the present invention, specifically, a separation unit including an ultrafiltration membrane may be easily prevented from gelation and stored for a long time.

Furthermore, the titanium dioxide sol containing the replaced organic solvent may be mostly commercially used as a material for nanofibers, wallpapers, lenses, and/or displays.

A method of preparing the above-described titanium dioxide sol according to the present invention, specifically, the solvent-replaced titanium dioxide sol, will now be described.

A method of preparing a titanium dioxide sol includes the steps of:

(a) preparing an organic solvent mixture containing a dispersing stabilizer by mixing 1 to 30 parts by weight dispersing stabilizer and 70 to 99 parts by weight organic solvent;

(b) preparing an organic solvent mixture containing an aqueous titanium dioxide sol and the dispersing stabilizer by mixing the organic solvent mixture containing the dispersing stabilizer of step (a) with the aqueous titanium dioxide sol in a volume ratio of 1:1 to 1:9;

(c) replacing water with an organic solvent by separating the organic solvent mixture containing the aqueous titanium dioxide sol and the dispersing stabilizer of step (b) into titanium dioxide particles, and an organic solvent mixture containing water and the dispersing stabilizer using a separation unit;

(d) circulating the separated titanium dioxide particles obtained in step (c) and mixing the separated titanium dioxide particles with the mixture of step (b); and

(e) repetitively allowing the organic solvent mixture prepared in step (b) to sequentially undergo steps (c) and (d) until the organic solvent has a purity degree of 95% or higher.

According to an exemplary embodiment, in step (d), the circulation of the titanium dioxide particles containing the replaced solution may further include cooling the circulated solution to room temperature or lower. Here, the cooling of the circulated solution may include maintaining the circulated solution at a low temperature equal to or lower than room temperature or lower to prevent gelation of sol during a solvent replacement process.

According to another exemplary embodiment, the method may further include providing an additional amount of organic solvent mixture containing the dispersing stabilizer as much as a reduced amount when the aqueous titanium dioxide sol and the organic solvent mixture containing the dispersing stabilizer contained in the mixture prepared in step (b) are reduced to 50% or more of initial capacity. Here, 50% of the initial capacity is not specifically limited but selectively determined by the user.

Meanwhile, a titanium dioxide sol containing the replaced solvent using the preparation method according to the present invention may be mixed with an organic solvent, a dispersant, a binder, a surfactant, or all thereof, and the mixture may be homogenized, thereby preparing paste for a screen printing process, specifically, a paste composition for a screen printing process. In this case, the dispersant, binder, and surfactant of the paste composition for the screen printing process may be a dispersant, a binder, and a surfactant which are typically known in the art.

In addition, a composition used for preparing titanium dioxide paste for a screen printing process according to the present invention includes the solvent-replaced titanium dioxide sol, an organic solvent, a binder, and a dispersant. The organic solvent may be preferably terpineol, butyl carbitol, or glycol acetate. The binder may be preferably ethyl cellulose, methyl cellulose, or propyl cellulose, and the dispersant may be preferably lauric acid, hydroxybenzoic acid, or polyethylene glycol-propylene glycol.

However, to facilitate explanation of the present invention, an example of a method of preparing the paste composition for the screen printing process will now be described.

To begin, the dispersant is added to the solvent-replaced titanium dioxide sol according to the present invention to be dispersed.

Here, the dispersant may be added at a content of 0.1 to 0.5% by weight, based on the solid content of the solvent-replaced titanium dioxide sol. Preferably, the dispersant may be hydroxybenzoic acid.

Thereafter, the titanium dioxide sol to which the dispersant is added is continuously stirred until a slurry-type precipitate is generated, thereby evaporating alcohol.

Thereafter, after terpiteol serving as the organic solvent is heated to a temperature of 70 to 100° C., ethyl cellulose serving as the binder was added at a content of 2 to 7% by weight based on the total weight of the mixture, sufficiently stirred, and then cooled at room temperature, thereby preparing a binder solvent.

In this case, after the binder is dissolved in the solvent, the binder functions to provide viscosity to the solvent so that the solvent can have specific viscous characteristics and have cohesiveness after drying of the paste composition.

Thereafter, the prepared titanium dioxide slurry and binder solvent are homogenized using a 3-roll mill, thereby preparing a final titanium dioxide paste composition for a screen printing process.

Hereinafter, the present invention will be described in detail with reference to the following Examples. However, it should be understood that the Examples proposed herein is just preferable examples for the purpose of illustrations only, not intended to limit the scope of the invention.

### Example 1

Acetylacetone (available from Junsei, Japan) serving as a dispersing stabilizer was added at a content of 5% by weight to ethanol (available from Samcheon, Republic of Korea) with a purity degree of 99%, which serves as an organic solvent, based on the total weight of the mixture to obtain the total volume of 1 L, thereby preparing an organic solvent mixture containing the dispersing stabilizer. The organic solvent mixture was stirred for approximately 30 minutes.

Next, an aqueous titanium dioxide sol (S5-300A available from Millennium Chemicals, USA) was mixed with the organic solvent mixture containing the dispersing stabilizer in a volume ratio of 1:1 and sufficiently stirred, and the above-described process was repeated using the titanium dioxide preparation apparatus of FIG. 1 under the condition of a temperature of 20° C. until water in the aqueous titanium dioxide sol was replaced with 95% or more of ethanol, thereby preparing solvent-replaced titanium dioxide sol.

In this case, an ultrafiltration (UF) membrane system (available from Kemicore, Republic of Korea) was used as the separation unit, and a heat exchanger (available from Kemicore, Republic of Korea) was used as the heat exchange unit.

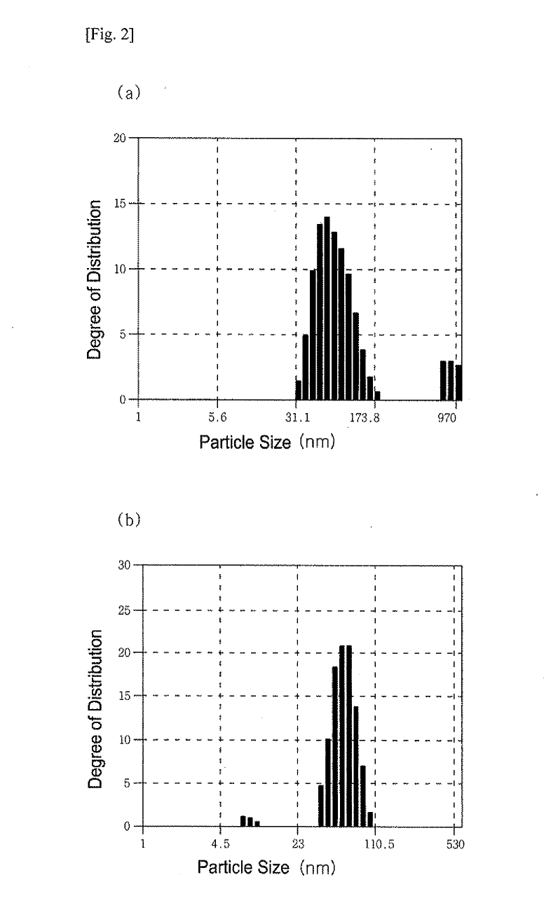

Meanwhile, to compare the particle sizes of the aqueous titanium dioxide sol before and after the solvent replacement, the particle size of the aqueous titanium dioxide sol was measured using a particle size analyzer (ELS-8000 available from Otsuka, Japan) and a transmission electron microscope (TEM) (JEM-4010 available from JEOL, USA), and measurement results are shown in FIGS. 2A, 2B, 3A, and 3B, 4, and 5.

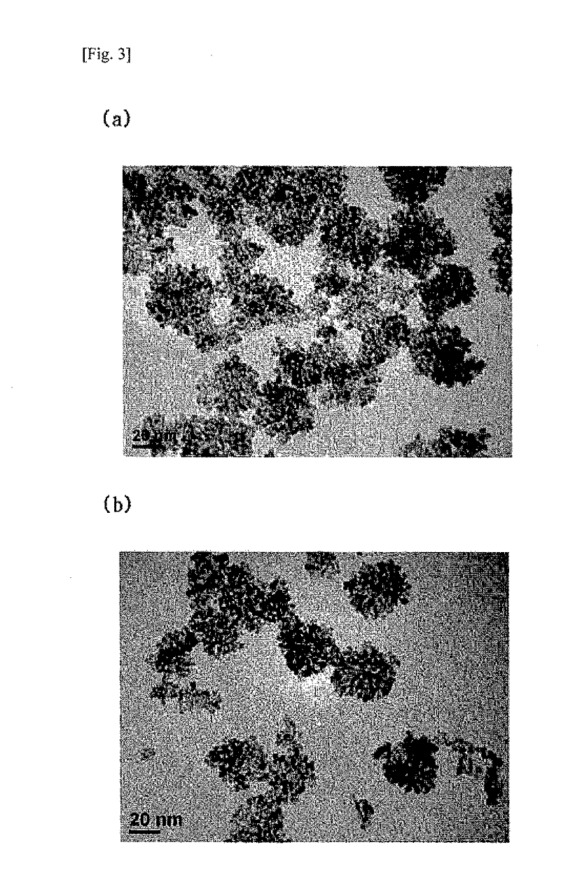

Here, FIGS. 2A and 3A show measurement results of the aqueous titanium dioxide sol after the solvent replacement process, while FIGS. 2B and 3B show measurement results of the aqueous titanium dioxide sol before the solvent replacement process.

As shown in FIGS. 2A and 3A, the ethanol-replaced titanium dioxide sol obtained to which acetylacetone serving as the dispersing stabilizer was added in the solvent had a particle size of approximately 60 nm. As shown in FIGS. 2B and 3B, before the solvent replacement process, the aqueous titanium dioxide sol had a particle size of approximately 50 nm.

The particle size of the solvent-replaced titanium dioxide sol was within the range (20 to 60 nm) of the particle size of the aqueous titanium dioxide sol before the solvent replacement process. Accordingly, after the solvent replacement process, it can be seen that there were little differences in the distribution of particle sizes between the solvent-replaced titanium dioxide sol and the aqueous titanium dioxide sol.

### Example 2

The same method was performed as in Example 1 except that methanol (available from Samcheon, Republic of Korea) with a purity degree of 99% was used instead of ethanol (available from Samcheon, Republic of Korea) with a purity degree of 99%.

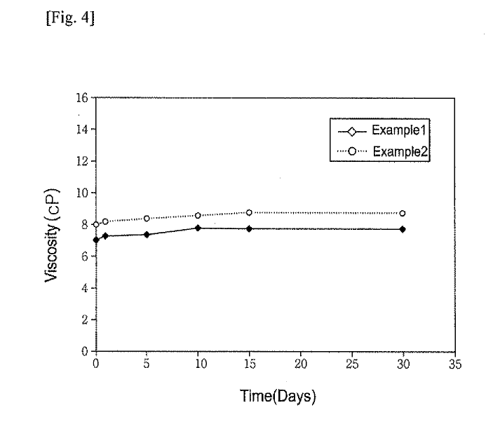

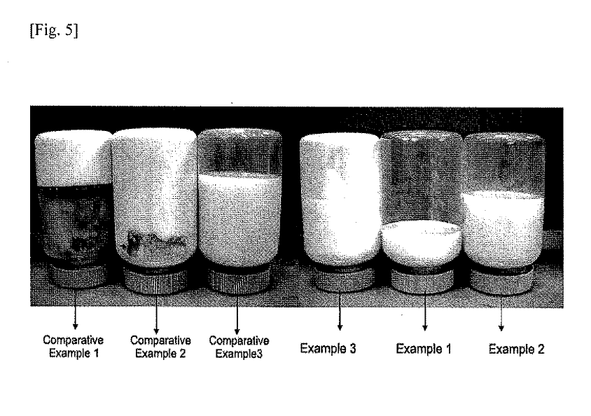

Results of Example 2 are shown in FIGS. 4 and 5,

Referring to FIG. 4, which is a graph showing variations in viscosities of a titanium dioxide sol replaced with ethanol serving as a solvent according to Example 1 and titanium dioxide sol replaced with methanol serving as a solvent according to Example 2 over time, it can be seen that initial viscosities of 7 cP and 8 cP hardly varied after 30 days had elapsed. Therefore, it can be inferred that the solvent-replaced titanium dioxide sols obtained according to Examples 1 and 2 remain stable after a long-term storage period.

### Example 3

The same method was performed as in Example 1 except that isopropanol (available from Samcheon, Republic of Korea) with a purity degree of 99% was used instead of ethanol (available from Samcheon, Republic of Korea) with a purity degree of 99%.

Results of Example 3 are shown in FIG. 5.

### Comparative Example 1

The same method was performed as in Example 1 except that acetylacetone was not used as the dispersing stabilizer.

Results of Comparative Example 1 are shown in FIG. 5.

### Comparative Example 2

The same method was performed as in Example 1 except that 5% by weight hydroxybenzoic acid (available from Acros Organics, USA) was used as the dispersing stabilizer instead of 5% by weight acetylacetone (available from Junsei, Japan).

Results of Comparative Example 2 are shown in FIG. 5.

### Comparative Example 3

The same method was performed as in Example 1 except that ethylene glycol (available from Samcheon, Republic of Korea) with a purity degree of 99% was used instead of ethanol (available from Samcheon, Republic of Korea) with a purity degree of 99%.

Results of Comparative Example 3 are shown in FIG. 5.

Referring to FIG. 5, solvent-replaced titanium dioxide sols prepared according to Comparative Examples 1 through 3 were gelled during a solvent replacement process or over time, while solvent-replaced titanium dioxide sols prepared by adding acetylacetone to the solvent according to Examples 1 and 2 were not gelled during a solvent replacement process or over time but remained stable for a long time.

However, a solvent-replaced titanium dioxide sol prepared using isopropanol to which acetylacetone was added according to Example 3 was gelled. Accordingly, it can be understood that acetylacetone cannot be always used as a dispersing stabilizer for preventing gelation.

### Example 4

0.4 g of hydroxybenzoic acid (available from Acros Organics, USA) serving as a dispersant was added to 10 g of the solvent-replaced titanium dioxide sol prepared according to Example 1 and continuously, sufficiently stirred until a slurry-type precipitate was generated, thereby preparing titanium dioxide slurry.

Next, terpineol (available from Kanto Chemical, Japan) serving as an organic solvent was heated at a temperature of 80° C., ethyl cellulose (available from Junsei, Japan) serving as a binder was added to the organic solvent at a content of 3% by weight based on the weight of a binder solvent, and the resultant mixture was sufficiently stirred and cooled at room temperature, thereby preparing the binder solvent which is a mixture of the organic solvent and the binder.

Thereafter, the prepared titanium dioxide slurry and 8 g of the binder solvent were processed using a 3-roll mill (EXAKT 50, Germany), thereby preparing titanium dioxide paste for a screen printing process.

### Example 5

To utilize the paste prepared according to Example 4 for a dye-sensitized solar cell, the paste was coated to a thickness of approximately 10 to 12 μm using a screen printing process on a fluorine-doped-tin-oxide (FTO)-coated conductive glass substrate (FTO22 available from Hartport Glass, USA), and annealed at a temperature of 500° C. to adsorb a dye for approximately 20 hours, thereby preparing a dye-coated semiconductor electrode.

Next, a counter electrode was formed by coating an FTO-coated conductive glass substrate (FTO22 available from Hartport Glass, USA) with platinum (Pt).

Thereafter, the prepared semiconductor electrode and the counter electrode were strongly bonded with each other using surlyn (available from Dupont, USA) by applying heat and pressure therebetween.

Next, an electrolyte solution (Iodolyte AN-50 available from Solaronix, Switzerland) was injected through fine pores previously formed in the counter electrode.

Thereafter, the fine pores were sealed using cover glass (available from Marienfeld, Germany) and surlyn (available from Dupont, USA) to prevent leakage of the electrolyte solution, thereby preparing a dye-sensitized solar cell.

To measure photocell characteristics of the dye-sensitized solar cell according to the present invention, current-voltage characteristics were analyzed using a 300 W xenon (Xe) lamp light source and an AM1.5 artificial sun (300 W Oriel, available from Newport, USA).

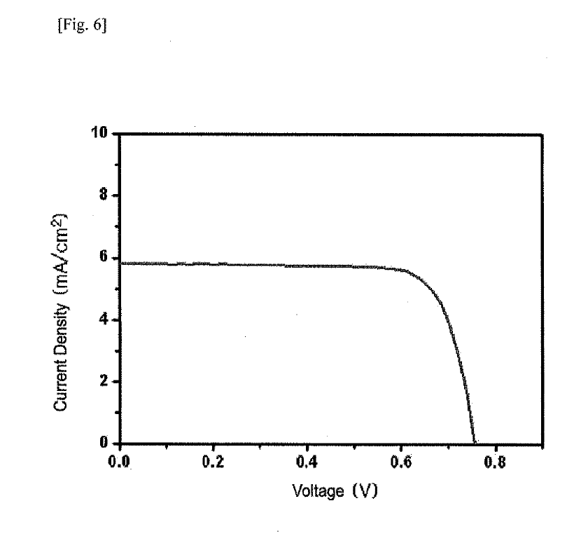

Results of Example 5 are shown in FIG. 6.

Referring to FIG. 6, a titanium dioxide sol dispersed in an organic solvent, which was obtained by replacing an aqueous titanium dioxide sol with a solvent, exhibited photocell characteristics of a current density Jsc of 5.8 mA/cm² and an open circuit voltage Voc of 0.75 V. Therefore, it can be seen that paste for a screen printing process applicable to dye-sensitized solar cells can be prepared using the solvent-replaced titanium dioxide sol.

While the invention has been shown and described with reference to certain exemplary embodiments thereof, it will be understood by those skilled in the art that various changes in form and details may be made therein without departing from the spirit and scope of the invention as defined by the appended claims.

1. An apparatus for preparing a titanium dioxide (TiO₂) sol, comprising:
a storage unit configured to store an organic solvent mixture containing an aqueous titanium dioxide sol and a dispersing stabilizer;
a separation unit connected to and installed at the storage unit and configured to separate the organic solvent mixture into titanium dioxide particles, and an organic solvent mixture containing water and the dispersing stabilizer;
a circulating solution transfer path connected and installed between the separation unit and storage unit and configured to transfer the titanium dioxide particles separated by the separation unit to the storage unit; and
a discharge unit connected to and installed at one side of the separation unit and configured to discharge the organic solvent mixture containing the water and the dispersing stabilizer separated by the separation unit.

2. The apparatus according to claim 1, further comprising a heat exchange unit included in the circulating solution transfer path and configured to control the temperature of the titanium dioxide particles separated by the separation unit.

3. The apparatus according to claim 1, further comprising:
a wash tank connected to and installed at one side of the separation unit and filled with a cleaning solution required to wash the separation unit; and
a cleaning solution transfer path connected and installed between the separation unit and the storage unit and configured to transfer the cleaning solution used to wash the separation unit to the storage unit.

4. The apparatus according to claim 3, further comprising a heat exchange unit included in the cleaning solution transfer path and configured to control the temperature of the cleaning solution used to wash the separation unit.

5. The apparatus according to claim 1, further comprising an organic solution injector installed at one side of the storage unit, wherein an organic solvent containing the dispersing stabilizer is injected into the organic solution injector.

6. The apparatus according to claim 1, further comprising a pH measurer connected to and installed at one side of the storage unit and configured to control the pH value of the organic solvent mixture containing the aqueous titanium dioxide sol and the dispersing stabilizer stored in the storage unit.

7. The apparatus according to claim 1, wherein the separation unit is an ultrafiltration membrane.

8. The apparatus according to claim 1, wherein the dispersing stabilizer is acetylacetone, polyvinylalcohol (PVA), or a mixture thereof.

9. The apparatus according to claim 1, wherein, the organic solvent mixture containing the dispersing stabilizer contains 1 to 30 parts by weight dispersing stabilizer and 70 to 99 parts by weight organic solvent.

10. A method of preparing a titanium dioxide (TiO₂) sol, comprising the steps of:
(a) preparing an organic solvent mixture containing a dispersing stabilizer by mixing 1 to 30 parts by weight dispersing stabilizer and 70 to 99 parts by weight organic solvent;
(b) preparing an organic solvent mixture containing an aqueous titanium dioxide sol and the dispersing stabilizer by mixing the organic solvent mixture containing the dispersing stabilizer of step (a) with the aqueous titanium dioxide sol in a volume ratio of 1:1 to 1:9;
(c) replacing water with an organic solvent by separating the organic solvent mixture containing the aqueous titanium dioxide sol and the dispersing stabilizer of step (b) into titanium dioxide particles and an organic solvent mixture containing water and the dispersing stabilizer using a separation unit;
(d) circulating the separated titanium dioxide particles obtained in step (c) and mixing the separated titanium dioxide particles with the mixture of step (b); and
(e) repetitively allowing the organic solvent mixture prepared in step (b) to sequentially undergo steps (c) and (d) until the organic solvent has a purity degree of 95% or higher.

11. The method according to claim 10, further comprising cooling a circulating solution to room temperature or lower during circulation of the titanium dioxide particles in step (d).

12. The method according to claim 10, further comprising providing an additional amount of organic solvent mixture containing the dispersing stabilizer to as much as a reduced amount when the aqueous titanium dioxide sol and the organic solvent mixture containing the dispersing stabilizer contained in the mixture prepared in step (b) are reduced to 50% or more of initial capacity.

13. The method according to claim 10, wherein the organic solvent is ethyl alcohol, methyl alcohol, isopropyl alcohol, butyl alcohol, ethylene glycol, or a mixture thereof.

14. A method of preparing a paste composition for a screen printing process, comprising mixing a titanium dioxide (TiO₂) sol prepared according to the method according to claim 10 with a dispersant, a binder, a surfactant, or all thereof and homogenizing the resultant mixture.
